(19) United States
(12) Patent Application Publication
(10) Pub. No.: US 2026/0189598 A1
(43) Pub. Date: Jul. 2, 2026

(54) IMPLEMENTING A QUEUING SYSTEM WITH AN ARTIFICIAL QUEUE FOR SUSPECTED BOT TRAFFIC

(71) Applicant: CLOUDFLARE, INC., SAN FRANCISCO, CA (US)

(72) Inventors: Piper McCorkle, Austin, TX (US); Oliver Conway Payne, Amsterdam (NL); Fabienne Heitiare Semeria, Redwood City, CA (US); Sally Lee, Mountain View, CA (US); Adam Erwin-Martinetti, Benicia, CA (US); Davis To, El Monte, CA (US); Arielle Loran Olache-Anderson, Charleston, SC (US)

(21) Appl. No.: 19/003,770

(22) Filed: Dec. 27, 2024

(51) Int. Cl. H04L 9/40

(52) U.S. Cl. CPC H04L 63/1441; H04L 63/08; H04L 63/1416; H04L 63/1425

(57) ABSTRACT

An edge server of a plurality of edge servers of a distributed cloud computing network receives a request from a requesting device to access a web application hosted at an origin server. The edge server sends a first page to the requesting device that includes a challenge. Based on a first response to the challenge, the edge server determines that the request has indications of being initiated by a malicious bot. The edge server sends a second response to the requesting device that includes a second page that indicates that the requesting device is in a queue. The queue is an artificial queue that has the appearance of a legitimate queue, but requests placed in the artificial queue do not ever reach the origin server. The edge server can periodically modify the second page to indicate progress in the artificial queue.

### FIELD

Embodiments of the invention relate to the field of network communications, and more specifically, to implementing a bot-detecting enhanced application queuing system in a distributed network.

### BACKGROUND

Hosts are concerned with maintaining high security, performance, and reliability of their hosted resources, such as applications and web resources (e.g., websites). As the popularity of a resource increases, so does the amount of network traffic that is directed to the origin server hosting the resource. This concern can be compounded when the resource is a target of automated scripts that imitate human activity (e.g., bots). For example, online sales of high demand items (e.g., products, tickets for music and sporting events, etc.) can attract a large number of bots, such as scalper bots, in addition to genuine users. This can result in a reduction in performance and user experience, as computing resources that should be directed to legitimate requests can become overwhelmed by non-legitimate requests from bots.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary networked system according to some embodiments described herein;

FIG. 2 illustrates a sequence diagram including operations performed by an edge server enforcing a virtual queueing process for requests according to an embodiment;

FIG. 3 is a flow diagram that illustrates exemplary operations of a method for detecting and managing requests from malicious bots to access a resource hosted by an origin server using artificial queues according to an embodiment; and

FIG. 4 illustrates a block diagram for an exemplary data processing system that may be used in some embodiments.

### DESCRIPTION OF EMBODIMENTS

Origin servers host resources that are accessible by a plurality of client devices. Requests for those resources may be received and processed at intermediary proxy servers such as those providing content delivery network (CDN) or other performance and/or security services. For instance, edge servers of a distributed cloud computing network may receive and process requests for the resources on behalf of the origin servers. In such situations, an edge server can either respond to the request using a stored version from a cache, or the edge server can forward the request so that the request can be served from the origin server. When the origin server experiences periods of high request volume that exceed the amount the infrastructure supporting the origin server can handle, the infrastructure supporting the origin server can fail. This can be exacerbated when the high request volume is at least partially being initiated by bots that attempt to gain an unfair advantage in accessing the resource by submitting multiple requests for the resource.

Some existing techniques to prevent bots from overwhelming an origin server with requests include using blacklists and filters that attempt to identify known bot traffic and block them from reaching the origin server. While these solutions can work with known bots, it has limited applicability unless they are consistently updated with new bots. Further, blocking the bots can result in an increase in network traffic as blocked bots can increase their requests or attempt to circumvent the block, further degrading the reliability and availability of requested resources.

The embodiments described herein provide mechanisms for mitigating heavy request traffic directed to a web application or resource by offloading requests indicative of being from bots to an artificial queue, while offloading legitimate requests from human users to a legitimate application queue. When an edge server receives a request directed to the web application or resource, a challenge is initiated using a bot detection system that determines whether the request has indications of being from a bot based on the response to the challenge and gathered signals/data points regarding the requesting client device. In response to determining that a bot is likely initiating the request, the edge server places the request in the artificial queue. The artificial queue can be designed to mimic the appearance and functionality of the legitimate application queue, including a time indication that can countdown towards zero. However, the countdown is an artifice that only gives the impression that the request in the artificial queue is progressing to reaching the intended destination (e.g., the origin server). Instead, the countdown may never reach zero and the request, once placed in the artificial queue, will not ever be serviced by the origin server. The artificial queue can further periodically rechallenge the requests to further exhaust the resources of the client device utilizing the bot.

Embodiments of the invention provide many technical advantages, in addition to addressing the deficiencies of previous solutions. For example, improvements to the processing of requests for resources hosted by an origin server from legitimate users can be realized by offloading non-legitimate, or undesirable, requests from bots to an artificial queue. This can further mitigate the possibility of the origin server from being inundated with more requests than it can handle at a given time, further ensuring the reliability, stability, and availability of the resource. This has the additional benefit of conserving resources for legitimate requests that would otherwise be expended on bot requests, resulting in an improved user experience.

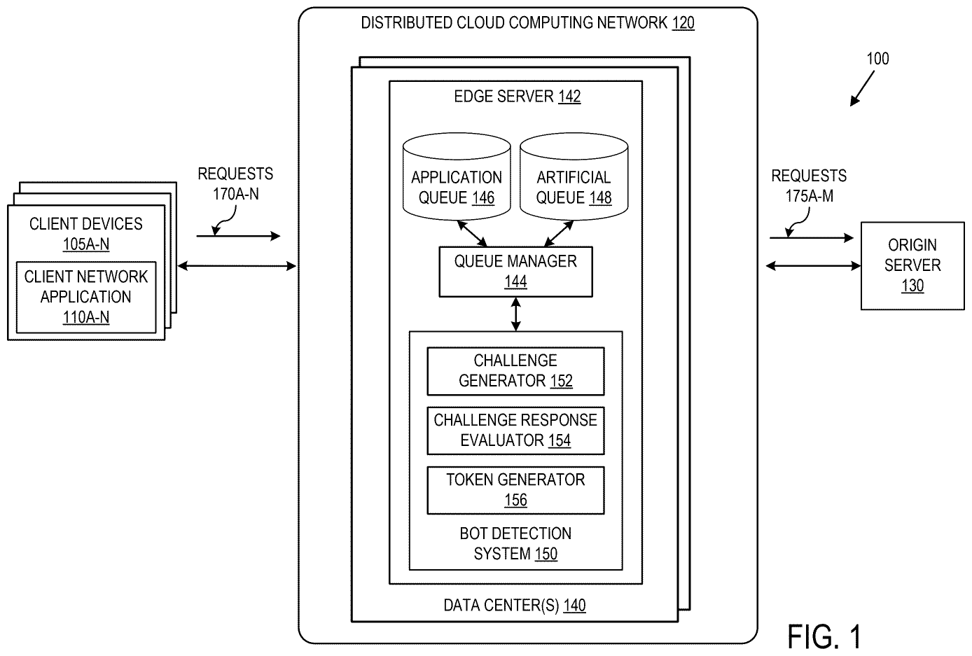

FIG. 1 illustrates an exemplary networked system 100 according to some embodiments described herein. The exemplary networked system 100 illustrated in FIG. 1 includes a distributed cloud computing network 120 situated between client devices 105A-N and an origin server 130. Distributed cloud computing network 120 includes data centers 140 that are geographically distributed. Each data center can also include one or more DNS servers (e.g., one or more authoritative name servers, one or more proxy DNS servers), and/or one or more other pieces of network equipment such as router(s), switch(es), and/or hubs. In an embodiment, each edge server within a data center may process network layer traffic (e.g., HTTP/S, SPDY, FTP, TCP, UDP, IPSec, SIP, other IP protocol traffic, or other network layer traffic). Each of data centers 140 can include one or more edge servers (e.g., edge server 142).

In some embodiments, the distributed cloud computing network 120 also includes a configuration server coupled to each of the data centers 140. In some embodiments, the configuration server is a centralized server that manages configuration data associated with the origin server 130. In such embodiments, the configuration server can push the configuration data to each of the edge servers 142.

Traffic destined for the application or resource, which is handled by the origin server 130, is received at the distributed cloud computing network 120. For example, the domain of the application or resource may resolve to IP address(es) of the distributed cloud computing network 120 (which may be anycast IP address(es)). The particular data center that receives a particular IP packet from a client device may be determined by the network infrastructure according to an Anycast implementation or by a geographical load balancer. For instance, the data centers 140 may each advertise the same anycast IP address for the origin. An IP packet with a destination IP address of that anycast IP address will be received at the data center that is closest to the requesting client device in terms of routing protocol configuration (e.g., Border Gateway Protocol (BGP) configuration) according to an anycast implementation as determined by the network infrastructure (e.g., router(s), switch(es), and/or other network equipment) between the requesting client device and the data centers.

Examples of client devices 105A-N include computing devices (e.g., laptops, workstations, smartphones, palm tops, mobile phones, tablets, gaming systems, set top boxes, wearable devices, electronic devices, etc.) that are capable of transmitting and/or receiving network traffic. In one embodiment, each of client devices 105A-N executes a client network application 110A-N that is capable of transmitting and/or receiving network traffic. For example, the client network application 110A-N may be a web browser or other application that can send requests to access and display network resources (e.g., web pages, images, word processing documents, PDF files, movie files, music files, or other computer files) hosted by the origin server 130.

Examples of an origin server 130 include computing devices that may serve and/or generate network resources (e.g., web pages, images, word processing documents, PDF files, movie files, music files, or other computer files). Origin server 130 may also be another edge server to the server that serves and/or generates network resources. Although not illustrated in FIG. 1, the network resources of origin server 130 may be stored separately from the device that responds to the requests. Origin server 130 may handle multiple domains that resolve to edge server(s) 142.

In some embodiments, when client devices 105A-N generate requests 170A-N directed to the origin server 130, the requests 170A-N are directed to or received by edge server 142 of a data center 140. In some embodiments, a geographical load balancer routes traffic to the nearest data center. Each edge server 142 can include a queue manager 144 and a bot detection system 150. In some embodiments, the queue manager 144 is a worker script. In some embodiments, when a request for application or resource hosted by the origin server 130 cannot be immediately served by the origin server 130, the queue manager 144 is configured to moderate access to the origin server 130 using one or more virtual queues (e.g., application queue 146 and artificial queue 148). For example, the queue manager 144 can be configured to receive a request to access resources at the origin server 130 and send the request to a bot detection system 150 to initiate a challenge process with the requesting client device.

In some embodiments, the bot detection system 150 includes a challenge generator 152, a challenge response evaluator 154, and a token generator 156. The challenge generator 152 can be configured to initiate a challenge to a requesting client device (e.g., client device 105A), for example, through a widget in a page sent to the requesting client device. The challenge can be an interactive or a non-interactive challenge. In some embodiments, the interactive challenge can be presented in a page displayed to the requesting client device. For example, the challenge can request a user input, such as a user interaction with a specified region of the page (e.g., a checkbox, object selection, object movement, etc.). In response to receiving the user input, the challenge response evaluator 154 can evaluate user input (e.g., how the user clicked a checkbox) to determine whether there are indications of a bot.

In some embodiments, the challenge generator 152 can instead use a non-interactive challenge, which does not require a user input. In such embodiments, code (e.g., JavaScript) can be executed in a browser on the requesting client device that collects signal or data points and transmits them back to the bot detection system 150. The challenge response evaluator 154 can then determine whether there are indications that there is a person using the browser or whether there are indications that the browser is automated. Example data points can include language used, window size, color bit depth, etc. The code can also detect whether the browser includes a captcha solving browser extension or similar applications.

When the challenge response evaluator 154 determines that the request is from a person, and not a bot, the token generator 156 can generate a challenge token that indicates the request is a legitimate request. In some embodiments, the challenge token is a cryptographically signed token that includes details of a challenge solve attempt. The challenge token can include a timestamp and/or other metadata to ensure that tokens cannot be hoarded (e.g., a valid period of five minutes). In embodiments, the challenge token contains no personal information and can only be redeemed once.

In embodiments, when the challenge response evaluator 154 determines that the request is from a bot (e.g., based on an analysis of the response), or if there was a timeout (e.g., no response was received to challenge after a predefined amount of time), the token generator 156 generates a challenge token that the queue manager 144 can analyze to determine whether it indicates that the request was from a bot.

In some embodiments, the queue manager 144 receives the challenge token from the bot detection system 150 or the client device 105A. The queue manager 144 can then determine whether to place requests in the application queue 146 or the artificial queue 148 based on the challenge token from the bot detection system 150. In some embodiments, the queue manager 144 can send the challenge token to a challenge token verification service (e.g., SiteVerify) to determine whether the challenge token indicates the request was legitimate or non-legitimate.

The queue manager 144 queues legitimate requests in the application queue 146 prior to sending them to the origin server 130. In embodiments, state data representing the number of requests admitted to the application or resource and the number of requests waiting to be admitted to the application or resource may be stored for each application queue 146. When placed in the application queue 146, a page can be displayed to the requesting client device that initiated the request. In such embodiments, the page can include a countdown value (e.g., a queue number, a clock, etc.) that indicates to a user of the requesting client device when their request may be removed from the application queue 146 and sent to the origin server 130.

The queue manager 144 queues non-legitimate requests (e.g., requests that have indications of being initiated by a bot, or other malicious requester) in an artificial queue 148. In some embodiments, a separate artificial queue 148 is created for each non-legitimate request and a queueing page is sent to the requesting device. In some embodiments, the artificial queue 148 emulates or mirrors the appearance of the application queue 146 used for legitimate requests, including the display of a page with a countdown value. This is to give the impression to a bot that the non-legitimate request has evaded detection and has been successfully placed in the application queue 146. To further this impression, the countdown value is periodically updated to give the impression that the non-legitimate request is progressing in a queue. However, in some embodiments, in contrast to the countdown value of the application queue 146, the countdown value of the artificial queue 148 asymptotically reaches zero. In this manner, the artificial queue 148 functions as an infinite queue. Thus, when a non-legitimate request is placed in the artificial queue 148, the non-legitimate request is not ever de-queued, and not able to reach the origin server 130.

In some embodiments, the artificial queue 148 can periodically initiate rechallenges to requesting client devices whose requests are in the artificial queue. The rechallenges can be visible (e.g., requiring interactions) or invisible (e.g., run in the background of the browser). In some embodiments, these rechallenges can be designed to be resource-intensive challenges that heavily utilize computing resources of the requesting client devices. Example rechallenges can include solving complex mathematical equations, identifying prime numbers, etc. In such embodiments, rechallenges that utilize high amounts of computing resources can limit the amount of bots that a malicious actor can deploy.

In some embodiments, legitimate requests can be incorrectly placed in the artificial queue 148 (e.g., false positives). In some embodiments, a customer can include informational messages in the page displayed to the requesting client device for the artificial queue 148. For example, an informational message may state, “You have failed a challenge, clear your cookies.” This can allow legitimate requests to be resent by the requesting client devices instead of being stuck in the artificial queue 148.

In some embodiments, information related to the application queue 146 and/or the artificial queue 148 can be used to improve the bot detection accuracy of the bot detection system 150. In some embodiments, the queue manager 144 can detect patterns in analytics for aggregated request traffic over time that can be used to profile client devices and requests as being bot traffic. For example, the queue manager 144 can log information related to a plurality of requests placed into the application queue 146 (e.g., requests that the bot detection system 150 may have determined to be legitimate). The queue manager 144 can determine from the logged information that a subset of the plurality of requests placed into the legitimate queue have indications of being attributable to malicious bots. In response, the queue manager 144 can flag requesting client devices associated with the subset of the plurality of requests based on determining that requests associated with the flagged requesting client devices have the indications of being attributable to malicious bots.

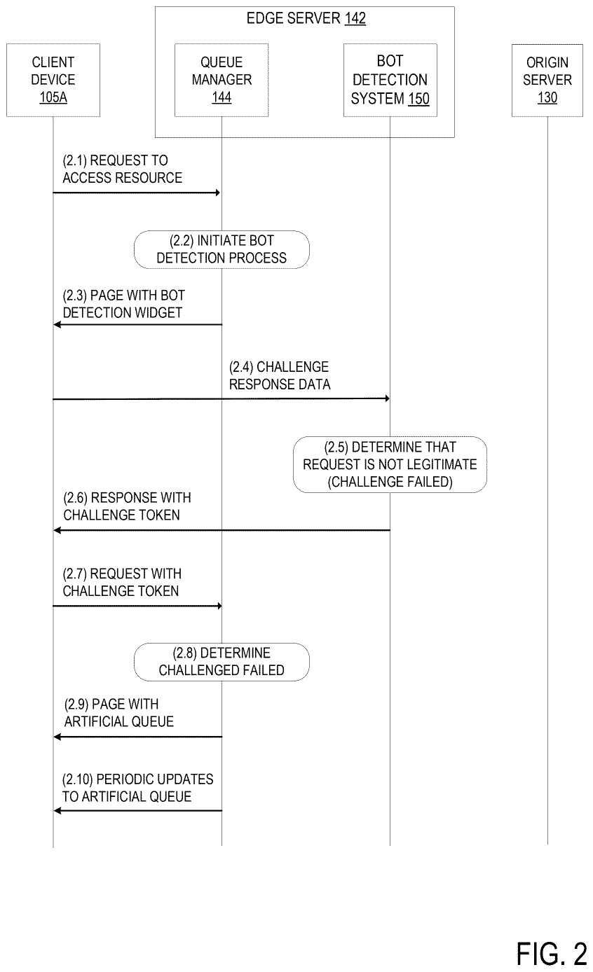

FIG. 2 illustrates a sequence diagram including operations performed by an edge server enforcing a virtual queueing process for requests according to an embodiment. At operation 2.1, client device 105A makes a request to access a resource that is received at edge server 142. For example, the request can be made by a client network application (e.g., client network application 110A in FIG. 1) operating on the client device 105A. The request can be generated in response to a selection of a link or URL (e.g., in a browser application). For example, edge server 142 receives an HTTP “GET” request to access a resource hosted by origin server 130. In one embodiment, the requested resource is a web page (e.g., an HTML page) located at, e.g., www.example.com/index.html. The request may include a request for an action to be performed on the resource.

At operation 2.2, a queue manager 144 of the edge server 142 initiates a bot detection process. In some embodiments, the edge server 142 initiates the bot detection process in response to determining that the resource cannot be immediately served by the origin server 130. For example, the origin server 130 may be experiencing a significant amount of traffic preventing it from completing the request and the edge server 142 determines that requests are to be queued in a virtual waiting room. In some embodiments, the queue manager 144 generates a page with a bot detection widget associated with a bot detection system 150.

At operation 2.3, the queue manager 144 sends the page with the bot detection widget to the client device 105A. The bot detection widget can cause a challenge to be displayed in the page at the client device 105A. The challenge can be an interactive or non-interactive challenge. The bot detection widget can collect signals or data points associated with a challenge response, the client device 105A, the browser application on the client device, etc.

At operation 2.4, the challenge response and challenge response data are sent to the bot detection system 150 for analysis. At operation 2.5, bot detection system 150 determines that the request is not legitimate, or that the challenge failed. In some embodiments, the bot detection system 150 analyzes the challenge response and data points associated with the client device 105A, the browser application on the client device, etc. to determine whether the request is a legitimate request from a human, is from a bot, or has indications of being from a bot or other malicious service. In embodiments, when the bot detection system 150 determines that the request is from a bot (e.g., based on an analysis of the response), or if there was a timeout (e.g., no response to the challenge was received after a predefined amount of time), the token generator 156 can generate a challenge token that can be used to determine if the first request was from a bot.

At operation 2.6, the bot detection system 150 sends a challenge token to the client device 105A. At operation 2.7, the client device 105A initiates a new request with the challenge token. At operation 2.8, the queue manager evaluates the challenge token and determines that the challenge failed. The queue manager 144 can send the challenge token to a challenge token verification service (e.g., SiteVerify) to determine whether the challenge token indicates the request was legitimate or non-legitimate. Based on the determination, the queue manager 144 can determine whether to place the request in an application queue or an artificial queue.

At operation 2.9, the queue manager sends the request to the artificial queue and sends a page to the client device 105A displaying information regarding the artificial queue. For example, the page emulates or mirrors the appearance of the application queue used for legitimate requests, including the display of a page with a countdown timer. However, once a request is placed in the artificial queue, the request is not able to be removed from the artificial queue and cannot access the resource at the origin server 130. At operation 2.10, the queue manager 144 periodically updates the artificial queue. In some embodiments, the updates include reducing the time of the countdown timer asymptotically to zero and/or initiating rechallenges to the client device 105A.

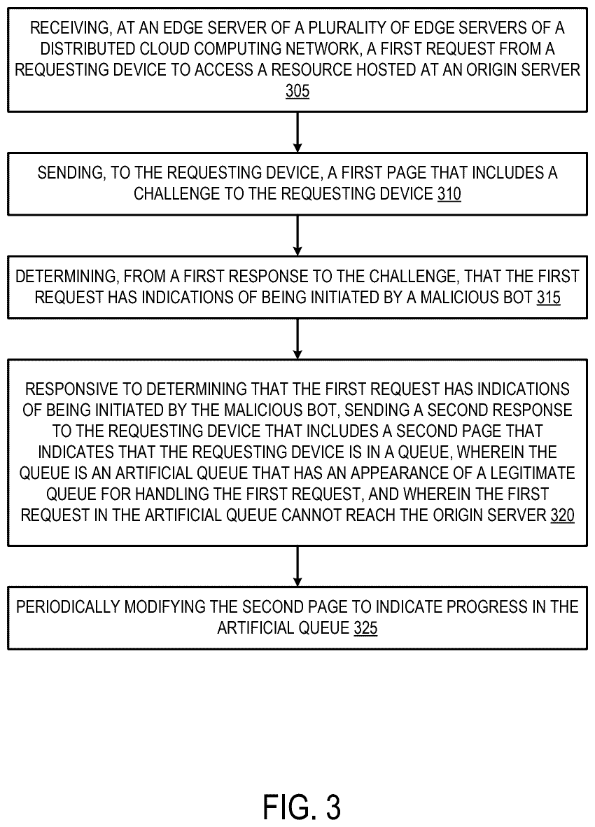

FIG. 3 is a flow diagram that illustrates exemplary operations of a method for detecting and managing requests from malicious bots to access a resource hosted by an origin server using artificial queues according to an embodiment. The operations of FIG. 3 will be described with reference to the exemplary embodiment of FIG. 1. However, the operations of FIG. 3 can be performed by embodiments other than those discussed with reference to FIG. 1, and the embodiments discussed with reference to FIG. 1 can perform operations different than those discussed with reference to FIG. 3. The operations of FIG. 3 are described as being performed by one or more edge servers (e.g., edge server 142) of a distributed cloud computing network (e.g., distributed cloud computing network 120).

In operation 305, an edge server of a plurality of edge servers of a distributed cloud computing network receives a first request from a requesting device to access a resource hosted at an origin server. The first request may include a request for an action to be performed on the resource hosted at the origin server. In some embodiments, the edge server receives the first request from a requesting client device. Examples of requesting client devices include computing devices (e.g., laptops, desktops, workstations, smartphones, palm tops, mobile phones, tablets, gaming systems, set top boxes, wearable devices, internet-of-things (IoT) devices, electronic devices, etc.) that are capable of transmitting and/or receiving network traffic. In some embodiments, the requesting client device executes a client network application that is capable of transmitting and/or receiving network traffic. For example, the client network application may be a web browser or other application that can access network resources (e.g., web pages, images, word processing documents, PDF files, movie files, music files, or other computer files).

In operation 310, the edge server sends a first page to the requesting device that includes a challenge to the requesting device. The challenge can be an interactive challenge that requires a user input or a non-interactive challenge that collects information regarding the requesting client device without a user input. In some embodiments, the first page can include a widget or application code that causes data regarding the requesting device to be transmitted to a bot detection system.

In operation 315, the edge server determines, from a first response to the challenge, that the first request has indications of being initiated by a malicious bot. In some embodiments, the edge server can cause a web browser displaying the first page to execute application code included in the first page. The application code can collect signals or data points or cause signals or data points to be collected that can be sent to a bot detection system. The first response can be sent to the bot detection system to determine, from the signals generated by the application code, whether the web browser is at least partially operated by the malicious bot. For example, the bot detection system can analyze the signals/data points associated with the requesting device and the first response to the challenge. Based on the analysis, the bot detection system can determine whether one or more of the analyzed signals/data points triggers one or more rules for profiling network traffic as being bot traffic, or indicative of bot traffic.

In operation 320, the edge server, responsive to determining that the first request has indications of being initiated by the malicious bot, sends a second response to the requesting device that includes a second page that indicates that the requesting device is in a queue, wherein the queue is an artificial queue that has an appearance of a legitimate queue for handling the first request, and wherein the first request in the artificial queue cannot reach the origin server. The artificial queue can include the same information and graphics as the legitimate application queue to convince a bot that the first request has evaded bot detection and has been placed in the legitimate application queue. The artificial queue can further rechallenge the requesting device to both suggest that the artificial queue is the legitimate application queue and to consume resources of the requesting device (e.g., through resource-intensive operations, such as complex mathematical equations).

In operation 325, the edge server periodically modifies the second page to indicate progress in the artificial queue. In some embodiments, at a refresh interval, a countdown on the second page can be modified. For example, where the countdown is a clock, the time on the clock can be asymptotically reduced to zero. Where the countdown is a numeric value (e.g., indicating a number of queued requests), the value can be reduced without reaching zero.

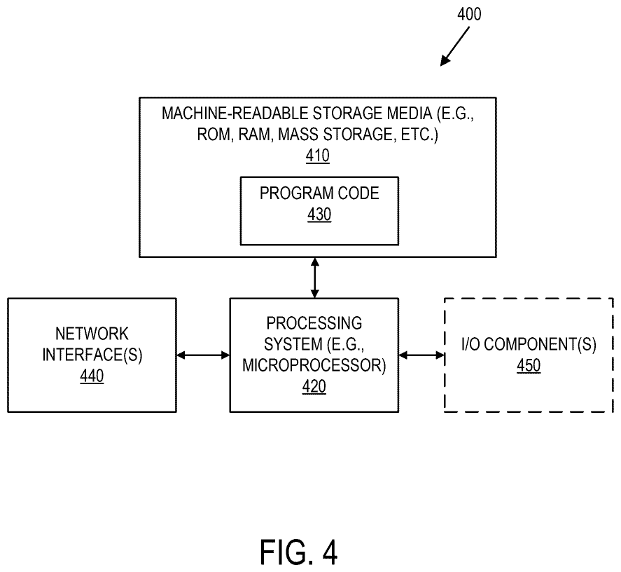

FIG. 4 illustrates a block diagram for an exemplary data processing system 400 that may be used in some embodiments. One or more such data processing systems 400 may be used to implement the embodiments and operations described with respect to the edge server, the data centers, or other electronic devices. The data processing system 400 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 410 (e.g., magnetic disks, optical disks, read only memory (ROM), flash memory devices, phase change memory, and other non-transitory computer-readable media) and machine-readable transmission media (also called a carrier) (e.g., electrical, optical, radio, acoustical or other form of propagated signals—such as carrier waves, infrared signals), which is coupled to the processing system 420 (e.g., one or more processors and connected system components such as multiple connected chips). For example, the depicted machine-readable storage media 410 may store program code 430 that, when executed by the processing system 420, causes the data processing system 400 to perform any of the operations described herein.

The data processing system 400 also includes one or more network interfaces 440 (e.g., a wired and/or wireless interfaces) that allows the data processing system 400 to transmit data and receive data from other computing devices, typically across one or more networks (e.g., Local Area Networks (LANs), the Internet, etc.). The data processing system 400 may also include one or more input or output (“I/O”) components 450 such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices.

Additional components, not shown, may also be part of the data processing system 400, and, in certain embodiments, fewer components than that shown in FIG. 4 may also be used in a data processing system 400. One or more buses may be used to interconnect the various components shown in FIG. 4.

Thus, an electronic device (e.g., a computer or a mobile client device) includes hardware and software, such as a set of one or more processors coupled to one or more machine-readable storage media to store code for execution on the set of processors and/or to store data. For instance, an electronic device may include non-volatile memory containing the code since the non-volatile memory can persist the code even when the electronic device is turned off, and while the electronic device is turned on that part of the code that is to be executed by the processor(s) of that electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

The techniques shown in the figures can be implemented using code and data stored and executed on one or more computing devices (e.g., client devices, servers, etc.). Such computing devices store and communicate (internally and/or with other computing devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals—such as carrier waves, infrared signals, digital signals, etc.). In addition, such computing devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given computing device typically stores code and/or data for execution on the set of one or more processors of that computing device. Of course, one or more parts of an embodiment of the invention may be implemented using different combinations of software, firmware, and/or hardware.

In the preceding description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the preceding description and the claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
receiving, at an edge server of a plurality of edge servers of a distributed cloud computing network, a first request from a requesting device to access a web application hosted at an origin server;
sending, to the requesting device, a first page that includes a challenge to the requesting device;
determining, from a first response to the challenge, that the first request has indications of being initiated by a malicious bot;
responsive to determining that the first request has indications of being initiated by the malicious bot, sending a second response to the requesting device that includes a second page that indicates that the requesting device is in a queue, wherein the queue is an artificial queue that has an appearance of a legitimate queue for handling the first request, and wherein the first request in the artificial queue cannot reach the origin server; and
periodically modifying the second page to indicate progress in the artificial queue.

2. The method of claim 1, wherein determining, from the first response to the challenge, that the first request has the indications of being initiated by the malicious bot further comprises:
analyzing data associated with the requesting device and the first response to the challenge; and
determining that one or more of the analyzed data associated with the requesting device and the first response to the challenge triggers one or more rules for profiling network traffic as being bot traffic.

3. The method of claim 1, wherein periodically modifying the second page to indicate progress in the artificial queue further comprises:
refreshing the second page and a display of a countdown timer in the second page, wherein the countdown timer asymptotically reaches zero.

4. The method of claim 1, wherein the first response include signals generated by application code included in the first page and executed by a web browser running on the requesting device, and wherein determining that the first request has indications of being initiated by the malicious bot further comprises:
determining, from the signals generated by the application code, whether the web browser is at least partially operated by the malicious bot.

5. The method of claim 1, wherein the requesting device is a first requesting device, and wherein the method further comprises:
receiving, at the edge server of the plurality of edge servers of the distributed cloud computing network, a second request from a second requesting device to access the web application hosted at the origin server;
sending, to the second requesting device, a third page that includes the challenge to the second requesting device;
determining, from a third response to the challenge, that the second request does not have indications of being initiated by the malicious bot; and
responsive to determining that the first request does not have indications of being initiated by the malicious bot, sending a fourth response to the second requesting device that includes a fourth page that indicates that the second requesting device is in the legitimate queue for handling the second request.

6. The method of claim 1, further comprising:
logging information related to a plurality of requests placed into the legitimate queue;
determining, from the logged information, that a subset of the plurality of requests placed into the legitimate queue have indications of being attributable to malicious bots; and
flagging one or more requesting devices associated with the subset of the plurality of requests based on determining that the subset of the plurality of requests placed into the legitimate queue have the indications of being attributable to malicious bots.

7. The method of claim 1, further comprising:
generating a challenge token that can indicate that the first request has the indications of being initiated by the malicious bot.

8. The method of claim 1, further comprising:
sending, to the requesting device, one or more web pages causing display of one or more additional challenges to the requesting device while in the artificial queue, including performance of resource-intensive operations by the requesting device.

9. A non-transitory machine-readable storage medium that provides instructions that, if executed by a processing system of an edge server of a plurality of edge servers of a distributed cloud computing network, will cause said edge server to perform operations comprising:
receiving, at the edge server of the plurality of edge servers of the distributed cloud computing network, a first request from a requesting device to access a web application hosted at an origin server;
sending, to the requesting device, a first page that includes a challenge to the requesting device;
determining, from a first response to the challenge, that the first request has indications of being initiated by a malicious bot;
responsive to determining that the first request has indications of being initiated by the malicious bot, sending a second response to the requesting device that includes a second page that indicates that the requesting device is in a queue, wherein the queue is an artificial queue that has an appearance of a legitimate queue for handling the first request, and wherein the first request in the artificial queue cannot reach the origin server; and
periodically modifying the second page to indicate progress in the artificial queue.

10. The non-transitory machine-readable storage medium of claim 9, determining, from the first response to the challenge, that the first request has the indications of being initiated by the malicious bot further comprises:
analyzing data associated with the requesting device and the first response to the challenge; and
determining that one or more of the analyzed data associated with the requesting device and the first response to the challenge triggers one or more rules for profiling network traffic as being bot traffic.

11. The non-transitory machine-readable storage medium of claim 9, wherein periodically modifying the second page to indicate progress in the artificial queue further comprises:
refreshing the second page and a display of a countdown timer in the second page, wherein the countdown timer asymptotically reaches zero.

12. The non-transitory machine-readable storage medium of claim 9, wherein the first response include signals generated by application code included in the first page and executed by a web browser running on the requesting device, and wherein determining that the first request has indications of being initiated by the malicious bot further comprises:
determining, from the signals generated by the application code, whether the web browser is at least partially operated by the malicious bot.

13. The non-transitory machine-readable storage medium of claim 9, wherein the requesting device is a first requesting device, and wherein the operations further comprise:
receiving, at the edge server of the plurality of edge servers of the distributed cloud computing network, a second request from a second requesting device to access the web application hosted at the origin server;
sending, to the second requesting device, a third page that includes the challenge to the second requesting device;
determining, from a third response to the challenge, that the second request does not have indications of being initiated by the malicious bot; and
responsive to determining that the first request does not have indications of being initiated by the malicious bot, sending a fourth response to the second requesting device that includes a fourth page that indicates that the second requesting device is in the legitimate queue for handling the second request.

14. The non-transitory machine-readable storage medium of claim 9, wherein the operations further comprise:
logging information related to a plurality of requests placed into the legitimate queue;
determining, from the logged information, that a subset of the plurality of requests placed into the legitimate queue have indications of being attributable to malicious bots; and
flagging one or more requesting devices associated with the subset of the plurality of requests based on determining that the subset of the plurality of requests placed into the legitimate queue have the indications of being attributable to malicious bots.

15. The non-transitory machine-readable storage medium of claim 9, wherein determining, from the first response to the challenge, that the first request has the indications of being initiated by the malicious bot further comprises:
generating a challenge token that can indicate that the first request has the indications of being initiated by the malicious bot.

16. The non-transitory machine-readable storage medium of claim 9, wherein the operations further comprise:
displaying one or more additional challenges to the requesting device while in the artificial queue, including performance of resource-intensive operations by the requesting device.

17. An edge server of a distributed cloud computing network, comprising:
a processor; and
a non-transitory machine-readable storage medium that provides instructions that, when executed by the edge server, cause the edge server to perform operations comprising:
receiving, at the edge server of a plurality of edge servers of the distributed cloud computing network, a first request from a requesting device to access a web application hosted at an origin server;
sending, to the requesting device, a first page that includes a challenge to the requesting device;
determining, from a first response to the challenge, that the first request has indications of being initiated by a malicious bot;
responsive to determining that the first request has indications of being initiated by the malicious bot, sending a second response to the requesting device that includes a second page that indicates that the requesting device is in a queue, wherein the queue is an artificial queue that has an appearance of a legitimate queue for handling the first request, and wherein the first request in the artificial queue cannot reach the origin server; and
periodically modifying the second page to indicate progress in the artificial queue.

18. The edge server of claim 17, determining, from the first response to the challenge, that the first request has the indications of being initiated by the malicious bot further comprises:
analyzing data associated with the requesting device and the first response to the challenge; and
determining that one or more of the analyzed data associated with the requesting device and the first response to the challenge triggers one or more rules for profiling network traffic as being bot traffic.

19. The edge server of claim 17, wherein periodically modifying the second page to indicate progress in the artificial queue further comprises:
refreshing the second page and a display of a countdown timer in the second page, wherein the countdown timer asymptotically reaches zero.

20. The edge server of claim 17, wherein the first response include signals generated by application code included in the first page and executed by a web browser running on the requesting device, and determining that the first request has indications of being initiated by the malicious bot further comprises:
determining, from the signals generated by the application code, whether the web browser is at least partially operated by the malicious bot.

21. The edge server of claim 17, wherein the requesting device is a first requesting device, and wherein the operations further comprise:
receiving, at the edge server of the plurality of edge servers of the distributed cloud computing network, a second request from a second requesting device to access the web application hosted at the origin server;
sending, to the second requesting device, a third page that includes the challenge to the second requesting device;
determining, from a third response to the challenge, that the second request does not have indications of being initiated by the malicious bot; and
responsive to determining that the first request does not have indications of being initiated by the malicious bot, sending a fourth response to the second requesting device that includes a fourth page that indicates that the second requesting device is in the legitimate queue for handling the second request.

22. The edge server of claim 17, wherein the operations further comprise:
logging information related to a plurality of requests placed into the legitimate queue;
determining, from the logged information, that a subset of the plurality of requests placed into the legitimate queue have indications of being attributable to malicious bots; and
flagging one or more requesting devices associated with the subset of the plurality of requests based on determining that the subset of the plurality of requests placed into the legitimate queue have the indications of being attributable to malicious bots.

23. The edge server of claim 17, wherein determining, from the first response to the challenge, that the first request has the indications of being initiated by the malicious bot further comprises:
generating a challenge token that can indicate that the first request has the indications of being initiated by the malicious bot.

24. The edge server of claim 17, wherein the operations further comprise:
displaying one or more additional challenges to the requesting device while in the artificial queue, including performance of resource-intensive operations by the requesting device.
